(19) United States
(12) Patent Application Publication
(10) Pub. No.: US 2017/0254317 A1
(43) Pub. Date: Sep. 7, 2017

(54) PISTON PUMP HAVING A REGION HAVING A NON-MAGNETIC MATERIAL IN THE MAGNETIC CIRCUIT

(71) Applicant: Robert Bosch GmbH, Stuttgart (DE)

(72) Inventors: Andreas Plisch, Marbach (DE); Frank Nitsche, Remseck Am Neckar (DE); Siamend Flo, Schwieberdingen (DE); Thorsten Allgeier, Untergruppenbach (DE); Walter Maeurer, Korntal-Muenchingen (DE)

(21) Appl. No.: 15/511,545

(22) PCT Filed: Aug. 13, 2015
(86) PCT No.: PCT/EP2015/068699

§ 371 Date: Mar. 15, 2017

(30) Foreign Application Priority Data
Sep. 16, 2014 (DE) 10 2014 218 594.7

(51) Int. Cl. F04B 17/04; H02K 1/02

(52) U.S. Cl. CPC F04B 17/04; H02K 1/02; F04B 35/045

(57) ABSTRACT

The invention relates to a piston pump, in particular for injection systems for motorized two-wheeled vehicles and/or for motorized three-wheeled vehicles, which piston pump comprises a housing, at least one magnetic coil, a cylinder, a piston arranged in the cylinder, and an armature plate having a stop for the piston, wherein the piston can be moved in the direction of the stop by a magnetic field produced by the magnetic coil, and wherein a magnetic circuit can be formed in the piston pump on the basis of the magnetic field, wherein in particular the piston, the cylinder, the housing, the armature plate, and the stop are components of the magnetic circuit, wherein at the stop-side reversal point of the piston, in particular when the piston hits the stop, the magnetic circuit has at least one region that has a non-magnetic material, in particular having a relative permeability μᵣ of not greater than 1.1.

### BACKGROUND OF THE INVENTION

The invention is based on a piston pump.

Electromagnetic piston pumps of the kind known today, as described in GB 2484855A for example, operate in accordance with the following principle: current is supplied to a magnet coil and said magnet coil generates a magnetic field in the process. A magnetic circuit is formed in the metallic and magnetizable components of the piston pump. The components of the magnetic circuit include, for example, the piston, the cylinder, the housing, the armature plate and the stop of the piston pump.

The magnetic field pulls the piston, which is arranged in the cylinder and also called the magnet armature, in the direction of the stop of the armature plate. During this process, a fluid is drawn through an inlet valve into a compression chamber which is arranged in the cylinder between the inlet valve in the cylinder base and the piston. If the magnetic field is switched off, a spring which is arranged between the piston and the stop pushes the piston (magnet armature) in the direction of the cylinder base and in the process firstly compresses the fluid and secondly pushes the fluid out of the compression chamber via the outlet valve.

Efforts are currently being made to increase the degree of efficiency of piston pumps and their functional reliability and also to improve the dynamics and the robustness of piston pumps.

### SUMMARY OF THE INVENTION

The invention is based on the knowledge that, after the magnetic field is switched off, so-called magnetic adhesion of the piston (magnet armature) to the stop is possible. This magnetic adhesion is the result of the residual magnetization of the magnetic circuit and its components, such as the piston, the cylinder, the housing, the armature plate and the stop for example, after the magnetic field is switched off. Consequently, the return force of the spring is insufficient to overcome the magnetic adhesion and to release the piston from the stop under certain circumstances.

However, the piston pump according to the invention has the effect that the magnetic adhesion is minimized or eliminated. This results in an increase in the functional reliability and an improvement in the dynamics of the piston pump.

To this end, it is provided that the magnetic circuit has at least one region which comprises a non-magnetic material at the stop-side reversal point of the piston, in particular when the piston stops against the stop. The expression “at the stop-side reversal point” means that the magnetic circuit and its components are taken into consideration at the point in time at which the piston is at its stop-side reversal point.

Within the meaning of the invention, particularly those components of the piston pump through which the eddy of the magnetic field extends with the maximum magnetic flux density belong to the magnetic circuit. Therefore, in particular, no components, regions or the like which are located outside the piston pump in the magnetic stray field are taken into consideration.

The region comprising the non-magnetic material has, in particular, a higher magnetic resistance (reluctance) Rₘ (DIN EN 80000-6) than the other components, such as the piston, the cylinder, the housing, the armature plate and the stop for example, in the magnetic circuit. As a result, the total magnetic resistance of the magnetic circuit is increased, so that the residual magnetization of the magnetic circuit dies away as quickly as possible and there is no magnetic adhesion of the piston to the stop. In particular, the region itself does not exhibit any residual magnetization or only negligible residual magnetization.

The magnetic resistance Rₘ of a component i in the magnetic circuit is given by:

R_{m,i}=Lᵢ/(μ₀μᵣAᵢ),

with the length L and the cross-sectional area A of the component i in the magnetic circuit and the vacuum permeability μ₀ and the relative permeability μᵣ of the material. The total magnetic resistance for the magnetic circuit is calculated analogously to the node and network rules of electrical resistance in an electrical circuit.

In addition to the metallic components of the electromagnetic piston pump, gaps between individual components can also contribute to the total magnetic resistance. The gaps can be filled with different materials, such as a gas for example, e.g. air or a liquid. By way of example, there is an air gap of variable length between the piston and the stop of the armature plate. The length of the air gap changes depending on the phase of the pumping cycle. After the magnetic field is switched off, the piston spring pushes the piston from the stop in the opposite direction and the air gap and its magnetic resistance increase. When the magnetic field is switched on, the piston is moved toward the armature plate and the air gap decreases. When the piston is fully drawn, that is to say the piston stops against the stop of the armature plate, the air gap and its magnetic resistance are minimal. The contribution of the air gap to the total magnetic resistance of the magnetic circuit is typically negligibly small in this phase of the pump cycle. The magnetic resistance of the air gap is then possibly too small to prevent the magnetic adhesion of the piston to the armature plate.

Therefore, according to the invention, a region comprising a non-magnetic material and, in particular, having a relatively high magnetic resistance in the magnetic circuit of the piston pump is provided, said region increasing the total magnetic resistance above a minimum value. The lower limit for the total magnetic resistance of the magnetic circuit of a piston pump depends on the dimensions of the piston pump. The total magnetic resistance of the magnetic circuit depends on the total volume and on the remanence properties of the materials of which the components which are situated in the magnetic circuit consist. The greater the total volume and the remanence of the materials used, the higher the minimum total magnetic resistance of the magnetic circuit has to be.

The region according to the invention has, in particular, a constant magnetic resistance within one pump cycle and/or over several pump cycles in comparison to the air gap between the piston and the stop. The region according to the invention is, in particular, not the variable air gap between the piston and the stop of the armature plate or the air gap between other components of the magnetic circuit.

One advantageous development of the piston pump according to the invention provides that the region comprises not only non-magnetic material but rather that the material is also a non-magnetizable or only weakly magnetizable material. In a preferred development, the region consists of the material. The material can have, for example, a relative permeability μᵣ of not greater than 1.1. In particular, μᵣ of the material is less than 1.

It has been found to be advantageous that the region comprises a material which has a solid aggregate state. By way of example, the region can be formed by a film/foil. The film/foil is preferably non-magnetic and/or non-magnetizable. Examples include plastic films, such as films comprising polyethylene (PE), polyamide (PA), polyoxymethylene (POM) or polystyrene (PS) for example.

As an alternative or in addition, the region can also be a coating on a component surface. The coating is preferably non-magnetic and/or non-magnetizable. By way of example, the coating can consist of chromium, a chromium alloy or a nitrided layer.

As an alternative or in addition, the region can also be formed by a treated surface. The treated surface can be, for example, nitrided (DIN 17022-4).

As an alternative or in addition, the region can also be a separating plate. The separating plate is preferably composed of a non-magnetic and/or non-magnetizable material, for example of a non-magnetic steel based on a cobalt/nickel alloy or a copper/beryllium alloy or a chromium/nickel alloy, available from Sandvik Materials Technology as Sandvik 13Rm19 for example.

The region typically has a thickness in the region of less than 5 mm. The thickness preferably lies in a range of from 1 μm to 500 μm, in particular in a range of from 10 μm to 100 μm. The thickness of the region depends on the dimensions of the piston pump, the selected material and/or the selected embodiment (separating plate, film/foil, coating, treated surface) of the region.

In principle, the region can be arranged at any point within the magnetic circuit. However, the region is preferably arranged on that side of the piston which faces the stop, also called the piston rear side. This has the advantage that the region with the low or negligible residual magnetization prevents direct contact between the piston and the stop of the armature plate and therefore reduces the mutual attraction between the piston and the stop on account of the residual magnetization. The probability of magnetic adhesion of the piston and of the stop is minimized in this way.

In addition or as an alternative, the region can be arranged on the surface of the stop. This has the same advantages as those described in the paragraph above.

If a region is formed both on the piston rear side and also on the surface of the stop, the regions on the piston rear side and the surface of the stop can consist of the same or different materials.

In addition or as an alternative to the region with a relatively high magnetic resistance, the probability of magnetic adhesion can also be reduced by the proportion of magnetic or ferromagnetic material, in particular iron-containing material, in the magnetic circuit being reduced.

This can be realized, for example, by a profile which is formed on that end side of the piston which faces the armature plate (piston rear side) and/or on the stop of the armature plate. The profile does not mean the hollow space which is formed within the piston and the associated opening at that end side of the piston which faces the armature plate, in which piston, for example, a spring is arranged.

The profile typically has a depth T of not less than 2% of a total length L of the piston and/or of not greater than 10% of the total length L of the piston, wherein the total length L of the piston is the distance from the end side which faces the armature plate to an end side of the piston which is situated opposite said end side.

The profile is advantageously formed by at least one, in particular annular or straight, groove. In this case, that end side of the piston which faces the armature plate has two regions which consist of different materials. There is, for example, a first region which consists of the same material as the piston. The second region is created by the groove/grooves being formed on the piston rear side or on the stop. This region is filled, for example, with air or fuel.

The groove can be annular or straight. The straight groove extends from the piston edge to the center of the piston rear side.

When providing a profile comprising a plurality of grooves, said grooves can be arranged parallel or at an angle β in relation to one another. The angle β between two grooves lies in the range of from 0°-180°, in particular in the range of from 22°-90°.

A plurality of grooves, which are arranged at an angle in relation to one another, typically have the same or a similar angle in relation to one another. The plurality of grooves advantageously each have an angle of approximately 360°/n between adjacent grooves, wherein n is the number of grooves.

The grooves can have a width of from 5% to 50% of the piston diameter. The greater the number of grooves, the narrower the individual groove. By way of example, a profile with a low number of grooves, in which the grooves are very wide, that is to say the groove width lies in the range of from 40%-50% of the piston diameter, or a profile with a large number of grooves, in which the individual grooves are narrower, that is to say the groove width lies in the range of from 5%-15% of the piston diameter, can be selected. The regions which are situated between the grooves and are composed of the piston material then assume the form of webs.

As an alternative, the profile can also be formed by at least one, in particular annular, step or by at least one bevel, in particular formed along the circumference. The bevel can be formed either from the piston rear side in the direction of the outer edge of the piston or from the piston rear side in the direction of the center of the piston rear side.

In addition to reducing the proportion of the magnetic material in the magnetic circuit, the provision of profiles on the piston rear side or on the stop has the further technical effect that the profile can be formed such that the profile experiences defined wear during operation of the pump. Owing to wear of the profile, the stroke of the piston increases and the piston pump can deliver more fluid in this respect. Secondly, wear also occurs between the piston and the cylinder wall, so that the gap between the piston and the cylinder wall increases over the service life of the piston pump. This leads to a reduction in the delivery quantity. The profile is ideally selected with its defined wear such that the increase in the stroke directly compensates for the losses in delivery quantity owing to the increasing gap between the piston and the cylinder wall, and therefore the degree of efficiency of the piston pump remains constant over the service life of the piston pump.

### BRIEF DESCRIPTION OF THE DRAWINGS

FIG. 1 shows an example of a piston pump according to the invention.

FIG. 2 shows a further example of a piston pump according to the invention.

FIG. 3 shows a further example of a piston pump according to the invention.

FIG. 4 a) shows a cross section through the piston with the piston rear side having a shoulder.

FIG. 4 b) shows a cross section through the piston with the piston rear side being beveled.

FIG. 5 a) shows a rear side of the piston with an alternative profile.

FIG. 5 b) shows a rear side of the piston with another alternative profile.

### DETAILED DESCRIPTION

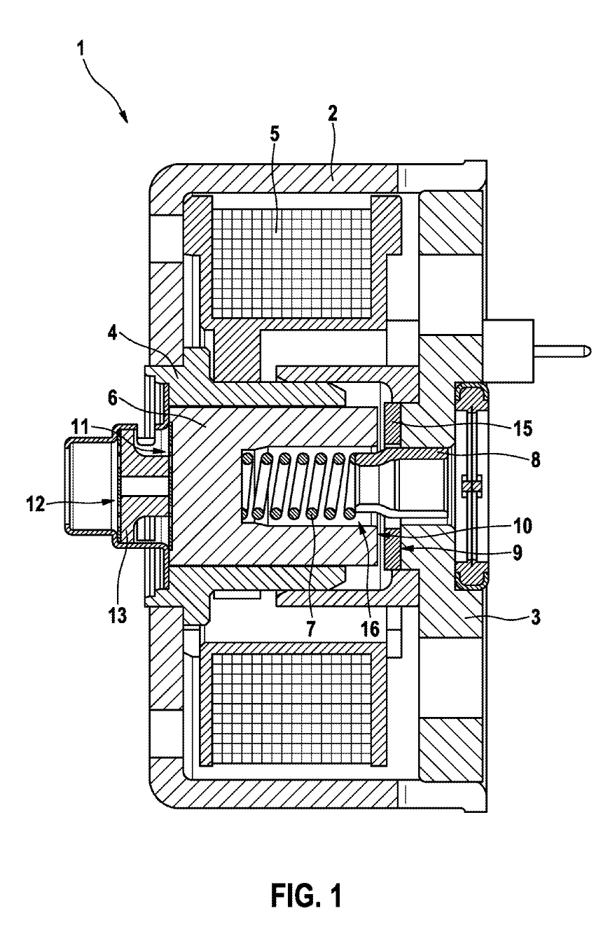

FIG. 1 shows a schematic illustration of a piston pump 1 according to the invention. The piston pump 1 has a housing 2, an armature plate 3 and a magnet coil 5 which is arranged in the housing 2, or a magnet coil set. A cylinder 4 is arranged radially in the interior of the magnet coil 5. A moving piston 6 is in turn arranged radially in the interior of the cylinder 4. The magnetic field which is generated by the magnet coil 5 moves the piston 6 in the direction of the armature plate 3. On its side which faces the piston 6, the armature plate 3 has a stop 9 against which the piston 6 stops when current is supplied to the magnet coil 5, that is to say when the magnetic field is switched on. That side of the piston 6 which faces the armature plate 3 is called the piston rear side 10. The area with which the piston rear side 10 makes contact with the stop 9 of the armature plate 3 when the magnetic field is switched on is called the contact area.

A piston spring 7 is arranged between the piston 6 and the armature plate 3. On that side of the piston spring 7 which faces the armature plate 3, said piston spring is fixed by a spring holder 8. The piston spring 7 can be arranged partially or completely within the piston 6. The piston rear side 10 then has an opening in which the piston spring 7 is arranged. The piston spring 7 is compressed owing to the piston movement in the direction of the armature plate 3. After the magnetic field is switched off, the piston spring 7 pushes the piston 6 back in the opposite direction.

Furthermore, an inlet valve 11 and an outlet valve 12 are arranged in the cylinder 4, in particular in the cylinder base. The cylinder 4 is delimited on one side by the armature plate 3 and on the opposite side by the cylinder base. The inlet valve 11 and/or the outlet valve 12 can be in the form of diaphragm valves. In this exemplary embodiment of a piston pump 1, the inlet valve 11 and the outlet valve 12 and therefore also the inlet and the outlet are arranged on the same side of the cylinder 4. In particular, the inlet and the outlet can be coaxial, for example the line for the outlet is arranged within the line for the inlet. A valve body 13 is arranged between the inlet valve 11 and the outlet valve 12.

Fuel lines via which a fuel is drawn from a tank, through the inlet valve 11, into the compression chamber within the cylinder 4 on account of the negative pressure are not shown. The negative pressure in the cylinder or in the compression chamber is created by the movement of the piston 6 in the direction of the armature plate 3. The fuel is pushed from the piston 6 to an injection valve via further fuel lines and the outlet valve 12.

In this exemplary embodiment, the surface of the stop 9 has a region 15. This region 15 is distinguished in that it consists of a non-magnetic and/or non-magnetizable or only weakly magnetizable material. The material of the region has, for example, a relative permeability μᵣ of less than 1.1, in particular of less than 1. The region preferably has a higher magnetic resistance than the other components, such as piston 6, cylinder 4, housing 2 and/or armature plate 3 for example, in the magnetic circuit.

The region 15 can be applied in the form of a film/foil or as a coating, for example as a chromium layer, to the surface of the stop 9 or can be a surface treatment, such as nitriding for example, or a separating plate. The thickness of the region 15 depends on the material used and/or the dimensions of the piston pump 1. The thickness of the region typically lies in the range of from 0.01 mm to 10 mm.

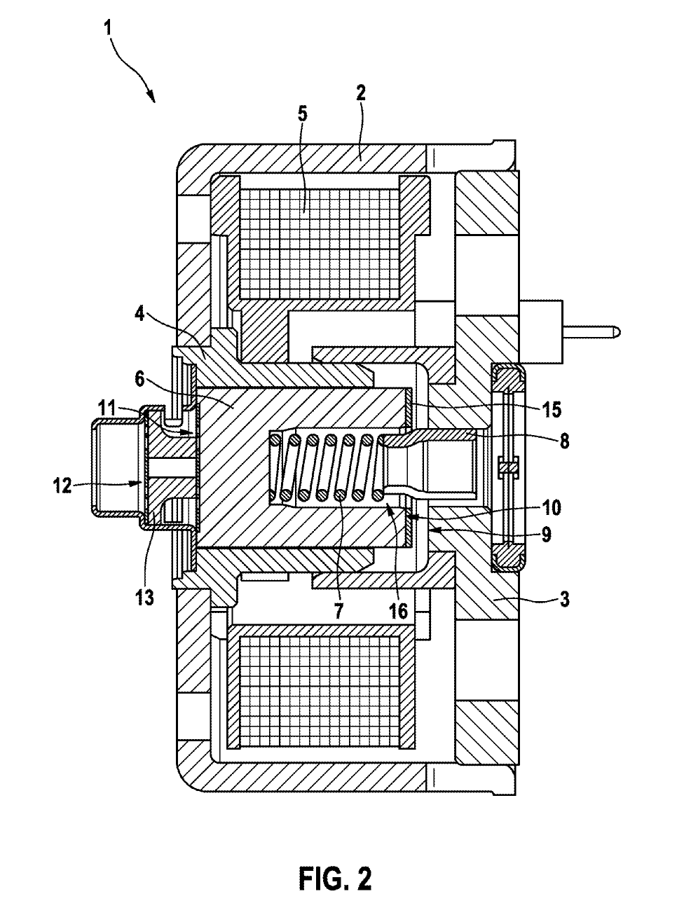

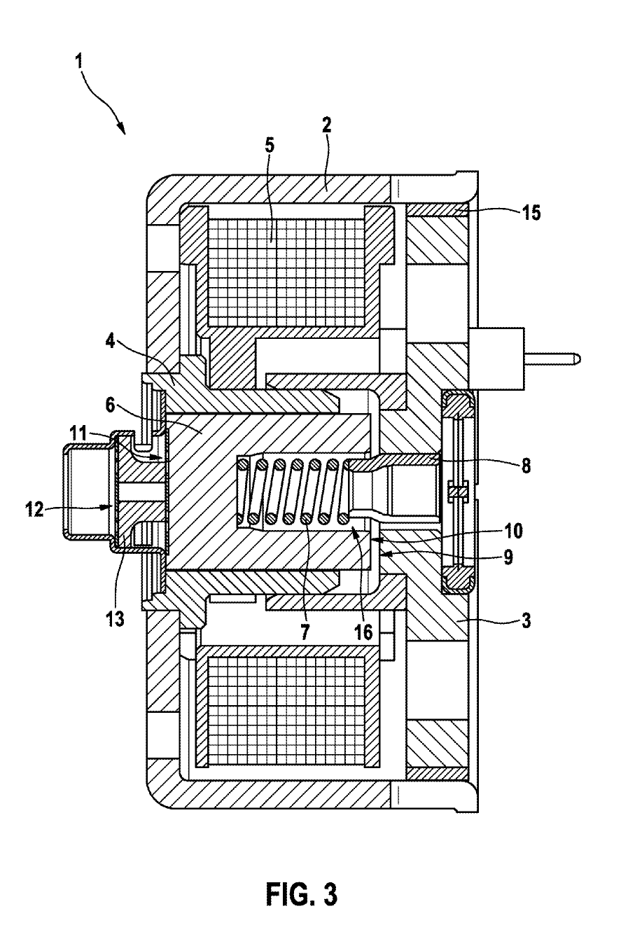

FIG. 2 and FIG. 3 show variants of the exemplary embodiment according to FIG. 1. Identical components are provided with identical designations and identified by the same reference symbols as in FIG. 1.

The exemplary embodiment according to FIG. 2 differs from the exemplary embodiment according to FIG. 1 in that the region 15 is arranged on the piston rear side 10. The region consists of a non-magnetic and/or non-magnetizable or only weakly magnetizable material and therefore has, in particular, a higher magnetic resistance (reluctance) than the other components in the magnetic circuit.

The exemplary embodiment according to FIG. 3 differs from the first two exemplary embodiments in that the region 15 is arranged between the armature plate 3 and the housing 2. The region 15 consists of a non-magnetic and/or non-magnetizable or only weakly magnetizable material and therefore has, in particular, a higher magnetic resistance than the other components in the magnetic circuit. The region is preferably formed by a separating plate in this exemplary embodiment.

The items and/or embodiments mentioned in the exemplary embodiments (separating plate, film/foil, coating, treated surface) for the region 15 can also be combined with one another. When combining the various exemplary embodiments, the region can consist of the same or different materials at the different points.

In addition or as an alternative, the piston rear side 10 can have a profile, so that the contact area between the piston rear side 10 and the stop 9 is reduced. This has the advantage that, owing to the relatively small contact area, the magnetic resistance increases and the proportion of ferromagnetic materials in the magnetic circuit reduces. Both effects counteract the residual magnetization of the magnetic circuit and its components. In addition to preventing magnetic adhesion of the piston 6 to the stop 9, wear of the piston 6 is also reduced and, respectively, the delivery quantity loss of the piston pump is compensated for, as already explained above.

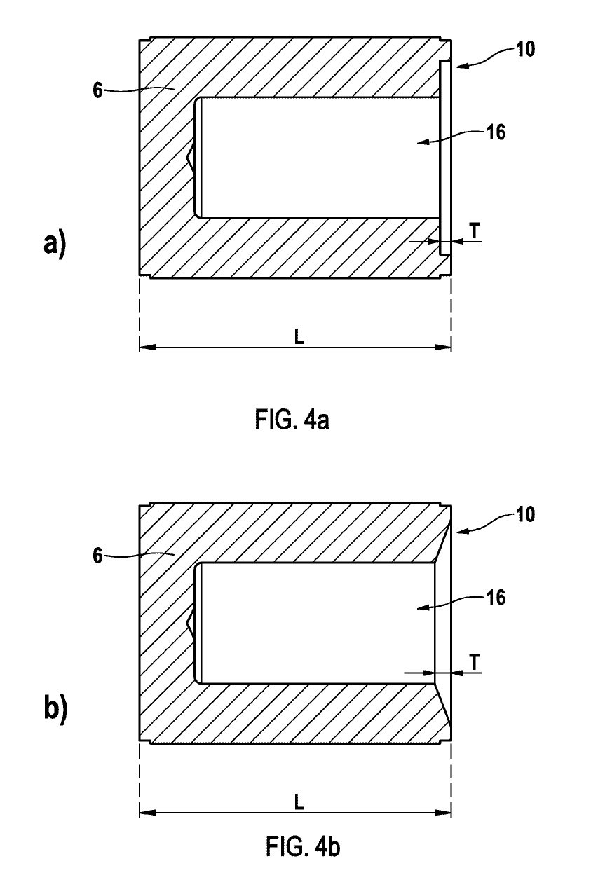

FIG. 4 shows a cross section through the piston 6, wherein the piston rear side has a further profile, in addition to the opening 16. In FIG. 4 a), the piston rear side 10 has a shoulder. In FIG. 4 b), the piston rear side 10 is beveled. In both cases, the contact area to the stop is reduced by at least 50% in comparison to a piston rear side 10 without a profile.

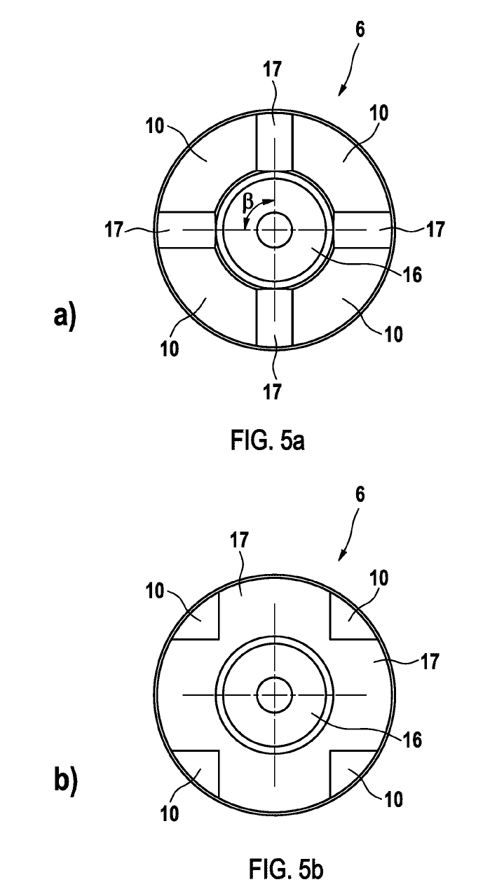

FIG. 5 shows the piston rear side 10 with two further alternative profiles. In FIG. 5 a), the piston rear side 10 has two grooves 17. The grooves are perpendicular to one another. In this example, the contact area of the piston rear side 10 corresponds to approximately ⅔ of the contact area 10 of the piston rear side without a profile. The grooves have a width of approximately 10% of the piston diameter.

When the width of the grooves 17 increases, the remaining contact area reduces in size, as shown in FIG. 5 b). In this example, the contact area of the piston rear side 10 corresponds to approximately ⅓ of the contact area of the piston rear side 10 without a profile. The grooves have a width of approximately 45% of the piston diameter.

The piston rear side 10 and its contact areas are worn over the service life of the piston pump 1, as a result of which the stroke of the piston 6 and therefore the stroke of the piston pump 1 increase. This increased stroke corresponds to an increase in the delivery quantity. Therefore, the wear which occurs between the piston 6 and the cylinder 4 and the associated loss of delivery quantity over the service life are compensated for.

The region 15 according to the invention, when combined with a profiled piston rear side 10, is preferably formed on the remaining contact area.

1. A piston pump (1), comprising a housing (2), at least one magnet coil (5), a cylinder (4), a piston (6) which is arranged in the cylinder (4), and an armature plate (3) with a stop (9) for the piston (6), wherein the piston (6) can be moved in a direction of the stop (9) by a magnetic field which is generated by the magnet coil (5), and wherein, on account of the magnetic field, a magnetic circuit can be formed in the piston pump (1), characterized in that the magnetic circuit has at least one region (15) which comprises a non-magnetic material.

2. The piston pump (1) as claimed in claim 1, characterized in that the region (15) consists of the non-magnetic material.

3. The piston pump (1) as claimed in claim 1, characterized in that the material has a solid aggregate state.

4. The piston pump (1) as claimed in claim 1, characterized in that the region (15) is a film/foil.

5. The piston pump (1) as claimed in claim 1, characterized in that the region (15) is a coating.

6. The piston pump (1) as claimed in claim 1, characterized in that the region (15) is a treated surface.

7. The piston pump (1) as claimed in claim 1, characterized in that the region (15) is arranged on a side of the piston (6) which faces the stop (9) or on the surface of the stop (9).

8. The piston pump (1) as claimed in claim 1, characterized in that the region (15) is arranged on a side of the piston (6) which faces the stop (9) and on the surface of the stop (9) of the piston (6), wherein the regions (15) on the piston rear side (10) and the surface of the stop (9) consist of the same or different materials.

9. The piston pump (1) as claimed in claim 1, characterized in that the end side (10) of the piston which faces the the armature plate (3) and/or the stop (9) of the armature plate (3) have/has a profile.

10. The piston pump (1) as claimed in claim 9, characterized in that the profile has a depth T of not less than 2% of a total length L of the piston (6) and/or of not greater than 10% of the total length L of the piston (6), wherein the total length L of the piston (6) is the distance from the end side (10) which faces the armature plate (3) to an end side (14) of the piston (6) which is situated opposite said end side (10).

11. The piston pump (1) as claimed in claim 9, characterized in that the profile is formed by at least one groove (15).

12. The piston pump (1) as claimed in claim 11, characterized in that the angle β which is enclosed between two grooves (15) lies in the range of from 0°-180°.

13. The piston pump (1) as claimed in claim 9, characterized in that the profile is formed by at least one step (19) or by at least one bevel.

14. The piston pump (1) as claimed in claim 1, wherein the piston pump is configured for use in injection systems for motorized two-wheeled vehicles and/or for motorized three-wheeled vehicles, wherein the piston (6), the cylinder (4), the housing (2), the armature plate (3) and the stop (9) are components of the magnetic circuit, and wherein the magnetic circuit has at least one region (15) which comprises a non-magnetic material with a relative permeability μᵣ of not greater than 1.1, at the stop-side reversal point of the piston (6), when the piston (6) stops against the stop (9).

15. The piston pump (1) as claimed in claim 1, characterized in that the region (15) is a non-magnetic film/foil.

16. The piston pump (1) as claimed in claim 1, characterized in that the region (15) is a chromium layer or a nitrided layer.

17. The piston pump (1) as claimed in claim 1, characterized in that the region (15) is a nitrided surface.

18. The piston pump (1) as claimed in claim 9, characterized in that the profile is formed by at least one annular or straight groove (15).

19. The piston pump (1) as claimed in claim 11, characterized in that the angle 0 which is enclosed between two grooves (15) lies in the range of from 22°-90°.

20. The piston pump (1) as claimed in claim 9, characterized in that the profile is formed by at least one annular, step (19) or by at least one bevel formed along the circumference.
